(19) United States
(12) Patent Application Publication
(10) Pub. No.: US 2024/0342058 A1
(43) Pub. Date: Oct. 17, 2024

(54) Pill Blender to Pulverize, Mix, and Blend Ingredients

(71) Applicant: Syed Umair Hussain, Karachi (PK)

(72) Inventor: Syed Umair Hussain, Karachi (PK)

(21) Appl. No.: 18/634,999

(22) Filed: Apr. 15, 2024

Related U.S. Application Data
(60) Provisional application No. 63/496,394, filed on Apr. 15, 2023.

(51) Int. Cl. A61J 7/00; B02C 18/10

(52) U.S. Cl. CPC A61J 7/0007; B02C 18/10

(57) ABSTRACT

A Pill Blender for pulverizing, mixing, and blending a variety of ingredients including medicaments, supplements, and other items is disclosed. The Pill Blender may include a container, a main assembly, an electrical motor, a rechargeable battery, a set of blades, and/or other components. The electrical motor is adaptive to be powered by a standard universal serial bus (USB) connection or by a rechargeable battery in the absence of external power supply. The set of blades may have specific arrangement and pointed edges for efficient crushing and blending, without leaving unprocessed ingredients in the container. The resulting mixture or powder may be consumed directly from the container or by dispensing it into another carrier. The Pill Blender is handheld, portable, efficient, and easy to clean device that operates relatively quietly, making it suitable for use in both home and professional settings.

### CROSS-REFERENCE TO RELATED APPLICATION(S)

This application is related to co-pending U.S. provisional patent application Ser. No. 63/496,394, filed Apr. 15, 2023, title “Pill Blender to Pulverize, Mix, and Blend Ingredients”, the disclosure of which is hereby incorporated by reference in its entirety.

### FIELD OF THE INVENTION

The present disclosure relates to a handheld portable blender that is configured to be powered by Universal Serial Bus (USB) port, having an electrical advantage to pulverize, mix, and blend various ingredients, including but not limited to medicaments and supplements, into powder, puree, or liquid form.

### BACKGROUND

The need to crush, puree, and blend ingredients in small quantities, such as medicaments and nutriments, into a desired form for easy swallowing and administration has been recognized due to clinical application requirements including swallowing difficulties, strong gag reflexes, medical complications, and unwillingness, among other reasons.

However, the current food processors are not specifically designed or suitable for crushing or mixing small ingredients like couple of pills or for making small liquid dosage of a few milliliters, among other limitations, as they often leave ingredients ungrounded and unblended, or ingredients get lost by sticking to the inside of the container assembly. Although, innovations like pill crushers, pill splitters, and pill grinders address specific individual needs, but they may have limitations in terms of, cleanliness, consistency, efficiency, and ability to disintegrate and mix different types and forms of ingredients. The present invention addresses these shortcomings by providing a portable, handheld device that can easily and effectively pulverize and mix ingredients of various types, sizes and quantities, including medicaments, nutriments, and other items, into desired forms.

### SUMMARY

The present disclosure relates to a Pill Blender that is configured to pulverize, mix and blend ingredients, including but not limited to medicaments, vitamins, supplements, and/or other items. By virtue of the set of blades being pointed and strategically positioned such that it enables the Pill Blender to have efficient and uniform processing of ingredients through a rotary motion that is adaptive to operate at low voltage.

A Pill Blender is effective for pulverizing and mixing the precise amount of ingredients into a powder or palatable mixture, avoiding any potential waste. The resulting mixture can be dispensed into a drink or food, making it easier to consume for individuals who have difficulty swallowing, are unwilling, or have medical complications. The Blender's removable container is also designed to be used as a cup for convenient consumption of the resulting mixture.

The Pill Blender may feature an ergonomic design that enables convenient hand-held operation, as well as the ability to be recharged and powered through a portable power source, such as a standardized universal serial bus (USB) connection. Furthermore, in certain embodiments, the Pill Blender may be equipped with a detector and safety switch mechanism that ensures proper attachment of the removable container and prevents or reduces unintentional activation of one or more components. Due to its true portability, ease of cleaning, and relatively quiet operation, the Pill Blender is travel-friendly and suitable for use at home, in professional settings, and various other locations, including community, healthcare, hospitality, and more.

The Pill Blender may include a container, a main assembly, an electrical motor, and/or other components. The term “mix” (and grammatical variations thereof) as used herein is intended to include other similar processes, such as blending, and is not intended to be limiting. As used herein, the term “ingredients” may encompasses a wide range of substances, including but not limited to medicaments (medicines or drugs), nutriments (essential nutrients), supplements (additional substances that may provide health benefits), vitamins, as well as other items such as water, milk, fresh juice, etc. The ingredients used herein may vary widely in terms of their physical properties, including their form (solid or liquid), consistency (hard, soft, or sticky), temperature (hot, cold, or room temperature), type (pills, tablets, capsules, or liquid), and any combination thereof.

The distinctive and novel features of the present invention are described in the claims section. To fully comprehend the invention, including its methods of operation, construction, additional objectives, functions of its elements, and advantages, it is essential to read the following description of the specific embodiments along with the accompanying drawings, which are part and parcel of this specification. The term “comprising” (and grammatical variations thereof) is used in this specification in the inclusive sense of “having” or “including”, and not in the exclusive sense of “consisting only of”. The drawings are provided only for illustrative and descriptive purposes and do not define the limits of the invention. In the specification and claims, the words “a,” “an,” and “the” may refer to one or more things unless the context clearly dictates otherwise.

### BRIEF DESCRIPTION OF THE DRAWINGS

Various embodiments are depicted in the accompanying drawings for illustrative purposes, and should not be interpreted as limiting the scope of the embodiments. Furthermore, the present invention will become better understood from the detailed description, appended claims, and accompanying drawing, wherein:

FIG. 1 shows a front view of a Pill Blender configured to pulverize and mix ingredients, with an indication for a cross-sectional view, in accordance with one or more implementations.

FIG. 2 shows a cross-sectional view of a Pill Blender, as indicated in FIG. 1, in accordance with one or more implementations.

FIG. 3 shows a top perspective view of a Pill Blender, in accordance with one or more implementations.

FIG. 4 shows a top bottom perspective view of a Pill Blender, in accordance with one or more implementations.

FIG. 5 shows a top view of a Pill Blender, in accordance with one or more implementations.

FIG. 6 shows a side view of a main assembly of Pill Blender, in accordance with one or more implementations.

FIG. 7 shows a top perspective view of a main assembly of Pill Blender, in accordance with one or more implementations.

FIG. 8 shows a bottom perspective view of a main assembly of Pill Blender, in accordance with one or more implementations.

FIG. 9 shows a bottom view of a main assembly of Pill Blender, in accordance with one or more implementations.

FIG. 10 shows an exploded, top perspective view of a Pill Blender, in accordance with one or more implementations.

FIG. 11A shows a front view of a lid of Pill Blender, in accordance with one or more implementations.

FIG. 11B shows a top perspective view of a lid of Pill Blender, in accordance with one or more implementations.

FIG. 11C shows a bottom view of a lid of Pill Blender, in accordance with one or more implementations.

FIG. 12A shows a top perspective view of a container of Pill Blender, in accordance with one or more implementations.

FIG. 12B shows a bottom perspective view of a container of Pill Blender, in accordance with one or more implementations.

### REFERENCE NUMERALS

The following is a list of reference numerals used in the drawings to refer to various components of the invention.

| | | | |
|---|---|---|---|
| 100 | Blender | 23 | Safety Switch |
| 100a | Entire Height | 24 | Distal End |
| 100b | Longitudinal Axis | 25 | Mechanical Coupling |
| 11 | Main Assembly | 26 | Outer Seal |
| 12 | Container | 27 | Shaft Housing |
| 13 | Lid | 27a | Inner Seal |
| 13a | Tenon | 27b | Stop Washer |
| 14 | Power Button | 28 | Container Body |
| 15 | Indicator | 28a | Open End |
| 16 | Storage Compartment | 28b | Base End |
| 17 | Proximal End | 28c | Chamfered Edge |
| 17a | Shoulder | 28d | Container Diameter |
| 17b | Mortise | 28e | Container Inner Wall |
| 18 | Main Body | 29 | Set of Blades |
| 18a | Main Body Neck | 29a | Shaft |
| 18b | Main Body Base | 29b | Pointed Edge |
| 18c | Coupling | 29c | Rotational Axis |
| 18d | Main Body Diameter | 29d | Blade Diameter |
| 19 | Power Interface | 29e | Offset |
| 20 | Control Circuitry | 29f | Rotational Direction |
| 21 | Electrical Motor | 30 | Logo |
| 22 | Rechargeable Battery | | |

### DETAILED DESCRIPTION

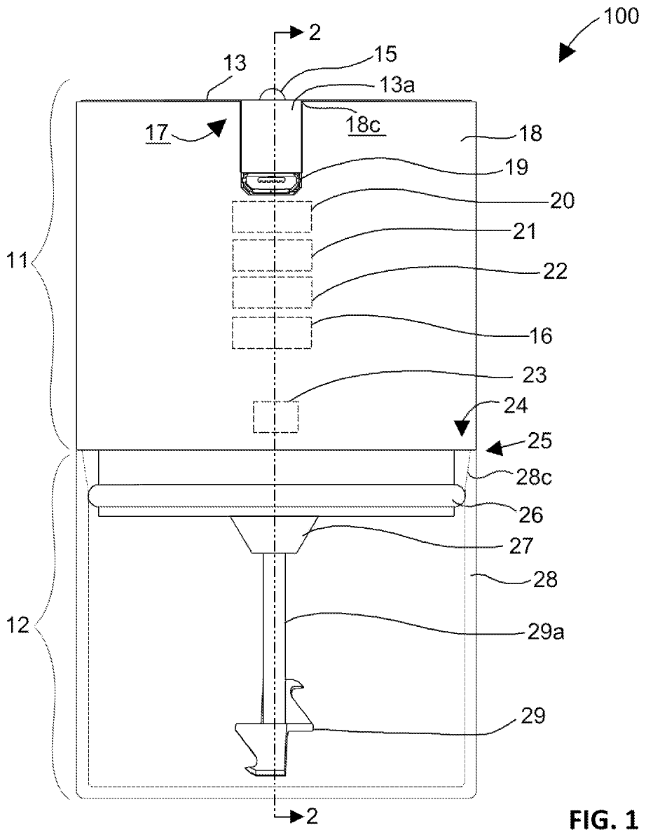

FIG. 1 shows a Pill Blender 100 (hereinafter referred to as Blender 100) that is configured to pulverize and mix ingredients, including but not limited to medicaments and nutriments, in accordance with one or more implementations. Blender 100 may include one or more of a main assembly 11, a container 12, and/or other components. The Main assembly 11 and container 12 may be configured to be coupled during blending by Blender 100. For example, in some implementations, the main assembly 11 and container 12 may be mechanically coupled, e.g., through slip fit connection. While leak-proof couplings may be preferred to prevent spills or leaks in Blender 100, other coupling designs may also be considered as alternatives, provided they ensure the safety, effectiveness, and efficiency of coupling without departing from the scope of the invention.

Referring to FIG. 1, components depicted in dashed rectangles may be enclosed within main assembly 11 of Blender 100.

Referring to FIG. 1, Main assembly 11 may include one or more of a set of blades 29, an electrical motor 21, a rechargeable battery 22, a storage compartment 16, a main body 18, a distal end 24, a proximal end 17, an outer seal 26, a shaft housing 27, a power interface 19, mechanical coupling 25, a safety switch 23, a power button 19, indicator 15, and/or other components.

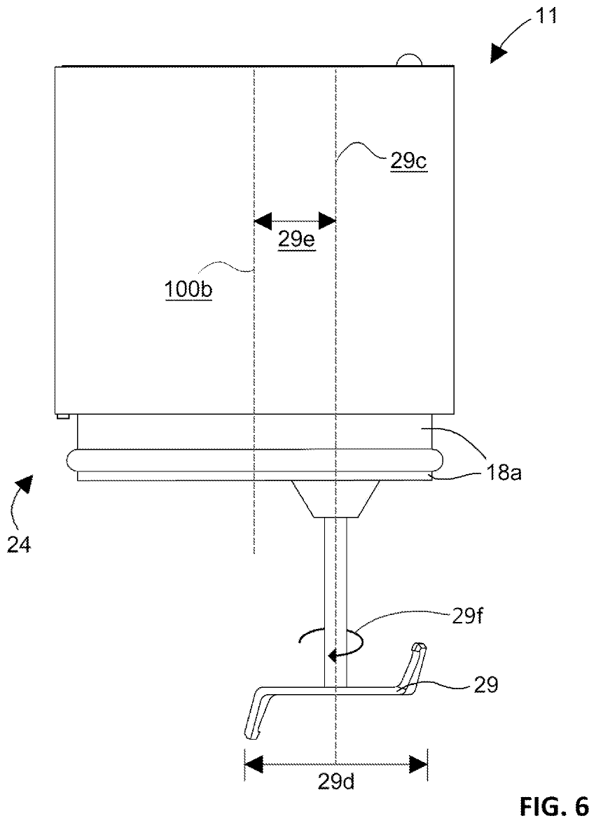

Referring to FIG. 1, proximal end 17 may be disposed at or near the lid 13 of the main assembly 11. Referring to FIG. 1 and FIG. 6, the distal end 24 may be disposed opposite to the proximal end 17, and may be positioned at or near the main body neck 18a, shaft 29a, shaft housing 27, inner seal 27a, safety switch 23, outer seal 26, and/or other components of the main assembly 11.

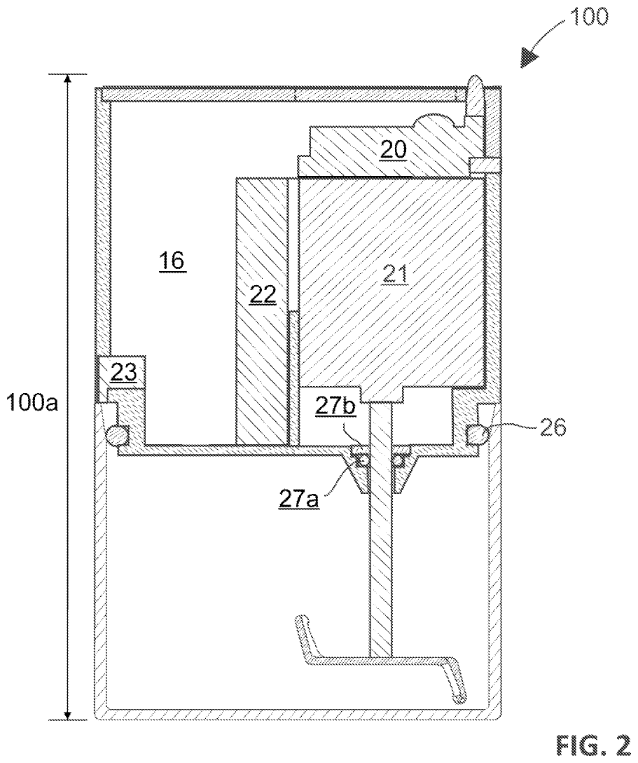

FIG. 1 shows a front view of Blender 100 with an indication for a cross-sectional view of Blender 100 in FIG. 2. By way of non-limiting example, FIG. 2 shows the position and arrangements of storage compartment 16, control circuitry 20, electrical motor 21, rechargeable battery 22, safety switch 23, outer seal 26, inner seal 27a, and/or other components which are enclosed within main assembly 11. FIG. 2 also illustrates an entire height 100a of Blender 100 when main assembly 11 and container 12 are being properly engaged. In some implementations, the entire height 100a of Blender 100 is between 2.5 and 6 inches. Wherein, in one or more preferential implementations, the entire height 100a of Blender 100 is 4 inches, approximately. Such a height may enhance portability, and may allow more comfortable handheld operation of Blender 100.

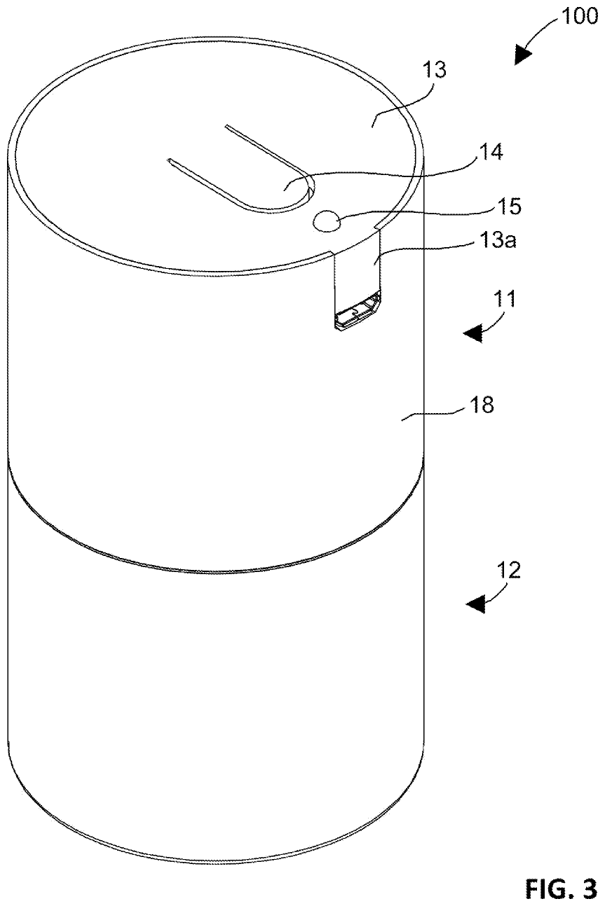

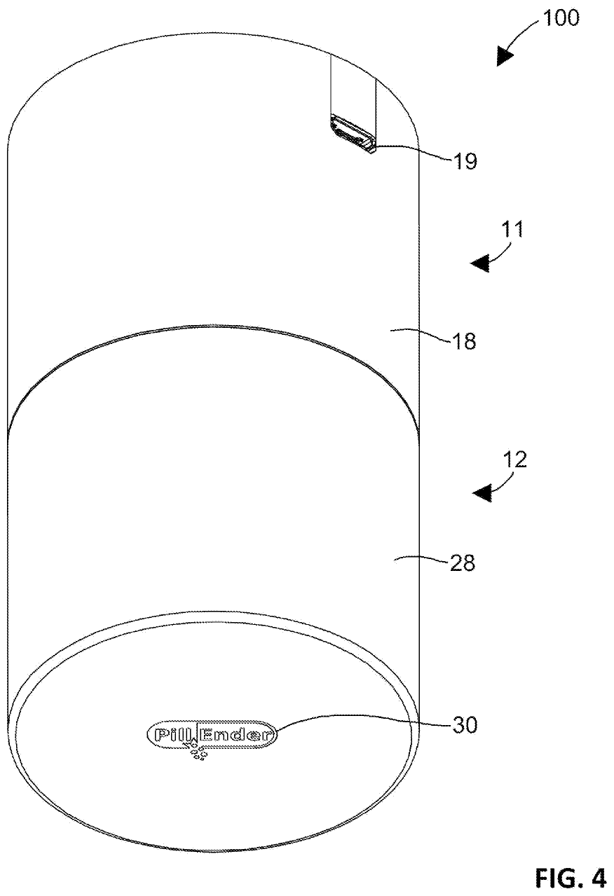

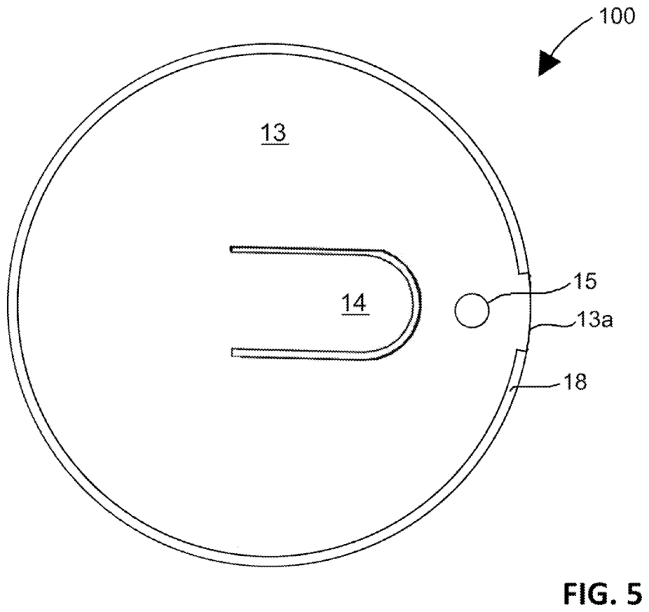

By way of non-limiting example, FIG. 3 shows an isometric elevation view of Blender 100 depicting its cylindrical shape. By way of non-limiting example, FIG. 4 shows a reverse isometric view of Blender 100 depicting its cylindrical shape, logo 30 (which may represent corporate branding), and/or other components. By way of non-limiting example, FIG. 5 shows a top view of Blender 100 depicting lid 13, Power button 14, indicator 15, and/or other components.

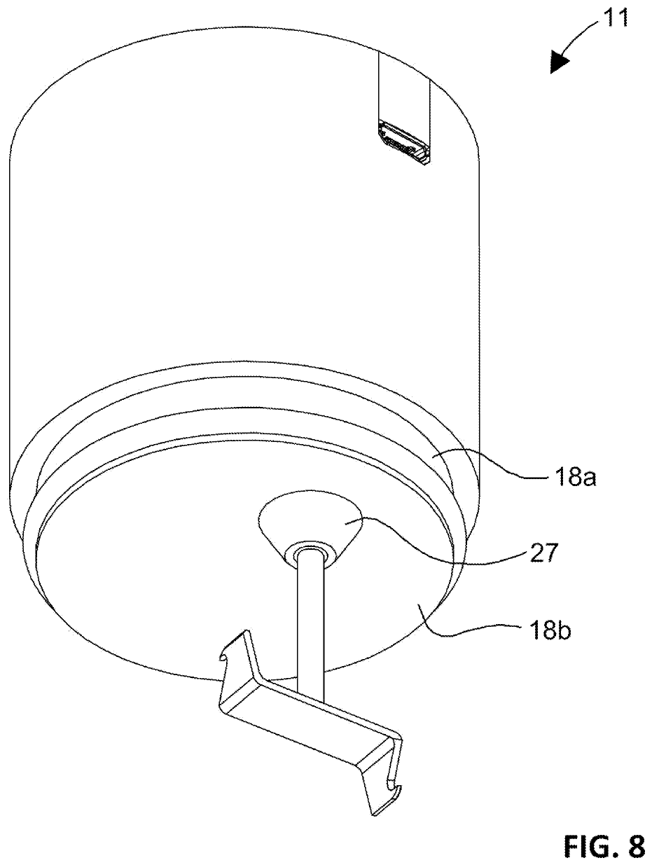

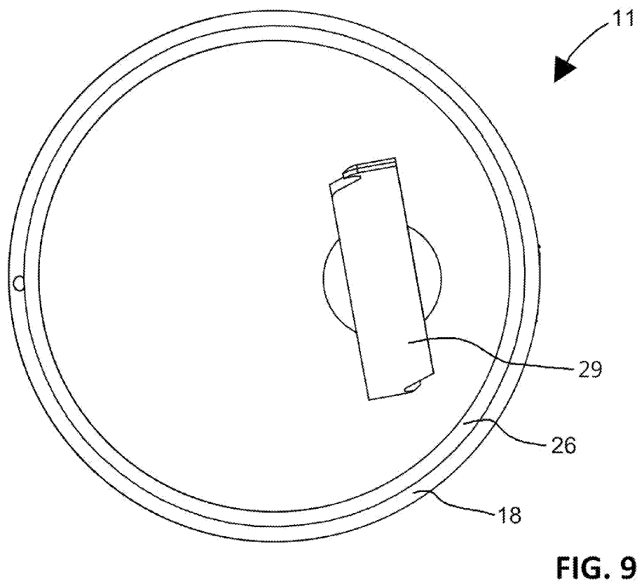

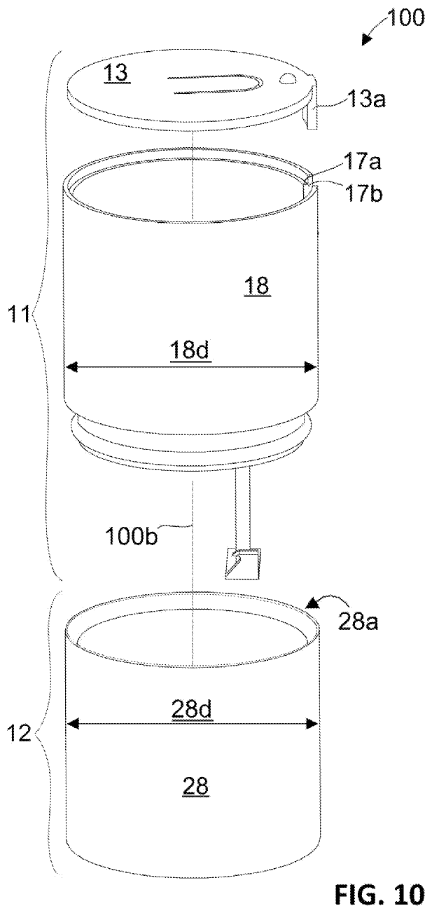

By way of non-limiting example, FIGS. 6-7-8-9 shows different views of main assembly 11 of Blender 100 that depict main assembly 11 as having a cylindrical shape (with the exception of set of blades 29). In some implementations, the cylindrical shape of main assembly 11 may have a diameter between 1.5 and 3 inches, which may be referred to as a main body diameter 18d (as show in FIG. 10). In some implementations, the cylindrical shape of main assembly 11 may have a main body diameter 18d of 2 inches, approximately. Such a main body diameter 18d may enhance portability, and may allow more comfortable handheld operation of Blender 100. For example, FIG. 6 shows side view of main assembly 11. FIG. 6 shows the arrangement and positioning of set of blades 29 in relation to the blade diameter 29d, the rotational axis 29c, and the longitudinal axis 100b, among other distinctive attributes. In some implementations, the blade diameter 29d may refer to largest distance measured between two opposite distal ends of set of blades 29, in a plane that is perpendicular to the rotational axis 29c. The blade diameter 29d of set of blades 29 is limited to be no greater than 95% of the container diameter 28d. In some implementations, the blade diameter 29d may be at least 32% of the container diameter 28d. In some implementations, the blade diameter 29d may be 50% of the container diameter 28d.

With reference to FIG. 6, the rotational axis 29c represents a non-physical line depicted as a dotted line extending infinitely through the set of blades 29. The set of blades 29 is arranged to rotate in a rotational direction 29f around the rotational axis 29c.

In some implementations, the rotational axis 29c may be parallel to the longitudinal axis 100b. In some implementations, the rotational axis 29c is offset from the longitudinal axis 100b by a distance referred to as 29e. In some implementations, the rotational axis 29c may be offset from the longitudinal axis 100b by a distance that may range up to 35% of the container diameter 29d. In some implementations, the offset distance 29e may be inversely proportional to the blade diameter 29d. Such that as the blade diameter 29d increases, the offset distance 29e may decrease until the rotational axis 29c aligns with the longitudinal axis 100b. Conversely, as the blade diameter 29d decreases, the offset distance 29e increases until the offset distance 29e of the rotational axis 29c from the longitudinal axis 100b measures up to 35% of the container diameter. In some implementations, the set of blades 29 may rotate such that at least one of its distal ends comes in close proximity to the container inner wall 28e to improve the efficiency and effectiveness of the blending process.

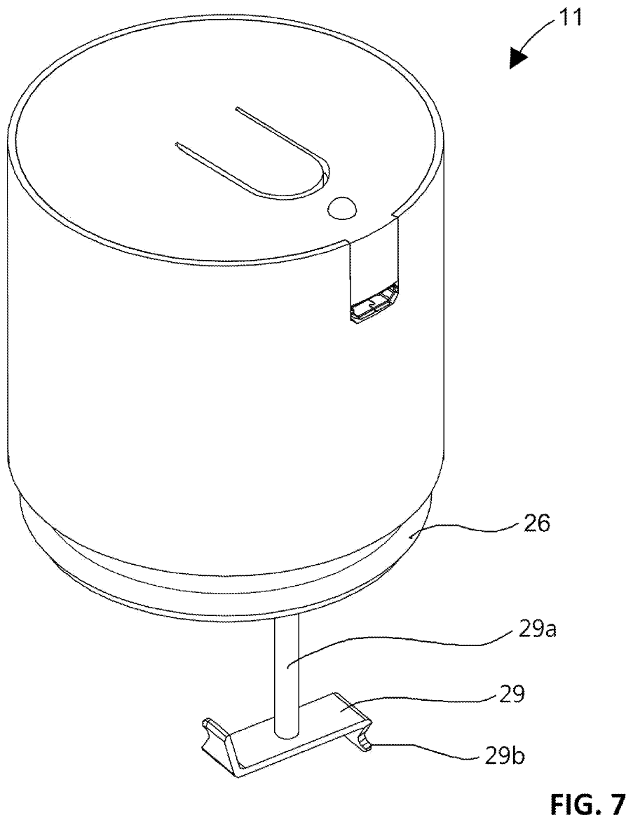

In the present invention, the set of blade 29 may be supported by a vertical shaft 29a. In some implementations, the vertical shaft 29a is rotationally connected to the main assembly 11 near the distal end 24. In some implementations, as depicted when the main assembly 11 is properly coupled to the container 12 in FIG. 1, the length of the vertical shaft 29a may be long enough to allow the set of blades 29 to be immersed directly into the ingredients present at the bottom of the container 12. In some implementations, the set of blades 29 may be connected permanently to the main assembly 11. In some implementations, the set of blades may include 2, 3, 4, 5, or 6 blades. In some implementations, as depicted in the upright configuration of main assembly 11 in FIG. 7, set of blades 29 may include two blades on opposite sides of rotational axis 29c. In some implementations, at least one blade of set of blades 29 may be curved downward, which may improve the pulverization and blending of ingredients present at the bottom of the container. In certain embodiments, as shown in the top perspective view of the main assembly 11 in FIG. 7, serrated or pointed edges 29b may be preferred, particularly for efficiently crushing hard-coated tablets and/or puncturing soft gels.

The set of blades 29 may be rotationally driven by an electrical motor 21. In some implementations, the electrical motor 21 may operate within a voltage range of 3V to 9V, with a preferred operating voltage of approximately 5V. In some embodiments, the electrical motor 21 may be capable of spinning the set of blades 29 at a maximum speed between 6000 and 20,000 RPM, with a preferred maximum speed of approximately 10,000 RPM. In some implementations, the electrical motor 21 may be powered through a power interface 19 by an external power supply.

In certain implementations, the electrical motor 21 may also be configured to be powered by a rechargeable battery 22. In some implementations, the rechargeable battery 22 is removable. The term “removable” refers to the rechargeable battery's ability to be used as a portable and convenient power source that can be stored for later use in the Blender 100, without the need for external power sources. In some implementations, the rechargeable battery 22 within the main assembly 11 may be accessed by removing the lid 21 from the main body 18. In certain embodiments, the rechargeable battery 22 is non-removable. The term “non-removable” means that the rechargeable battery 22 is permanently connected with other components in the main assembly 11, and cannot be accessed by user during blending operation, cleaning, and for storage for later user. In some implementations, rechargeable battery 22 may have a capacity between 500 mAh and 3500 mAh. In one or more preferential embodiments, the rechargeable battery 22 may have a capacity under 1000 mAh.

Rechargeable battery 22 may be configured to be charged through power interface 19 using power from an external power source. In the present invention, power interface 19 may be configured to conduct electrical power to electrical motor 21. In some implementations, power interface 19 may be a standardized USB port that receives an electrical connector from an external power source. In certain embodiments, power interface 19 may be further configured to support wireless charging of rechargeable battery 22 from an external power source using induction-based and/or resonant charging. In certain embodiments, the power interface may be covered for aesthetics, protection, and/or other reasons.

The control circuitry 20 of the Blender 100 may comprise of a printed circuit board (PCB) and/or a combination of different electronic components that work together. In some implementations, the control circuitry 20 may be configured to seamlessly control the operation and different features of the Blender 100, including but not limited to the control of indicating modes of indicator 15, power button 14 for turning the Blender 100 on and off, switching between power sources to power Blender 100 operations either from rechargeable battery 22 or directly from external power supply through power interface 19, and charging the rechargeable battery 22 while also ensuring that it stops charging when the rechargeable battery 22 is fully charged. In some implementations, the control circuitry 20 may also prevent or allow rotation of the set of blades 29 by controlling the power supply to the electric motor 21 based on the detection by the safety switch 23.

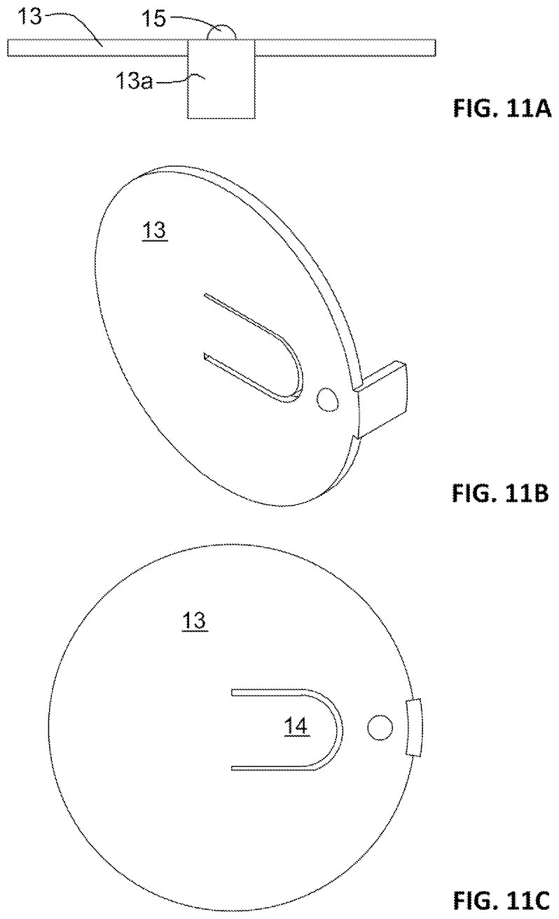

Referring to FIG. 1, lid 13 may be disposed at or near proximal end 17 of main assembly 11. In some implementations, Lid 13 may be removable. For example, removing lid 13 may expose storage compartment 16, rechargeable battery 22 and/or other components by creating opening near proximal end 17 in main assembly 11. In some implementations, storage compartment 16 may be designed to allow storing and/or travelling with ingredients without the need for additional containers for storing ingredients, e.g., pills. By way of non-limiting example, FIG. 11A illustrates a front view of lid 13, FIG. 11B shows a perspective view of lid 13, and FIG. 11C shows a bottom view of lid 13. In some implementations, lid 13 may include a tenon 13a, power button 14, indicator 15, and/or other components for functioning of Blender 100. Tenon 13a may be configured to ensure that lid 13 is properly aligned and engaged with main body 18 (as shown in FIG. 1 and FIG. 4).

Power button 14 may be included as part of the user interface of Blender 100. Power button 14 may be designed to be activated manually, for example by pushing and/or pressing down the power button 14 to enable basic functions including turning Blender 100 on and off. Referring to FIG. 5, in some implementations, the power button 14 may be a part of lid 13 itself and is designed to flex and bend in response to pressure, like a cantilevered button based on compliant mechanism. In some implementations, power button 14 may protrude from the surface of the lid 13. In some implementations, the power button 13 may have the capability to alternate the power supply for electrical motor 21 between a rechargeable battery 22 and an external power source from power interface 19. In some implementations, the Blender 100 may be controlled by a user through the use of a switch, and/or other types of user interfaces that allows turning the appliances on and off as needed.

Referring to FIG. 1, in some implementations, coupling 18c of main assembly 11 may be configured to couple lid 13 to main body 18 and/or other components of main assembly 11. In some implementations, coupling 18c may be a mechanical joint. In some implementations, coupling 18c may comprise on tenon 13a, shoulder 17a, and mortise 17b (as shown in FIG. 10). By way of non-limiting example, FIG. 10 illustrates how lid 13 and main body 18 may fit together by using “tenon and mortise joint”, in accordance with one or more implementations. Here the term “tenon and mortise joint” refers to a joint that is used to connect two pieces by using tenon as a projection that fits into square or rectangular slot, known as mortise. Tenon 13a may be configured to properly align and position lid 13 on main body 18, and/or other components of the main assembly 11. In some implementations, tenon 13a may help ensure that the lid 13 and/or other components are securely coupled and functioning properly with the rest of the Blender 100.

Safety switch 23 may be configured to detect whether main assembly 11 is safely or properly coupled to container 12 for blending by Blender 100. In some implementations, safety switch 23 may comprise on one or more momentary switches included at or near distal end 24 of main body 18. In some implementations, safety switch 23 may be configured to activate and allow rotation of electrical motor 21 based on the compression applied to the safety switch 23 by container 12.

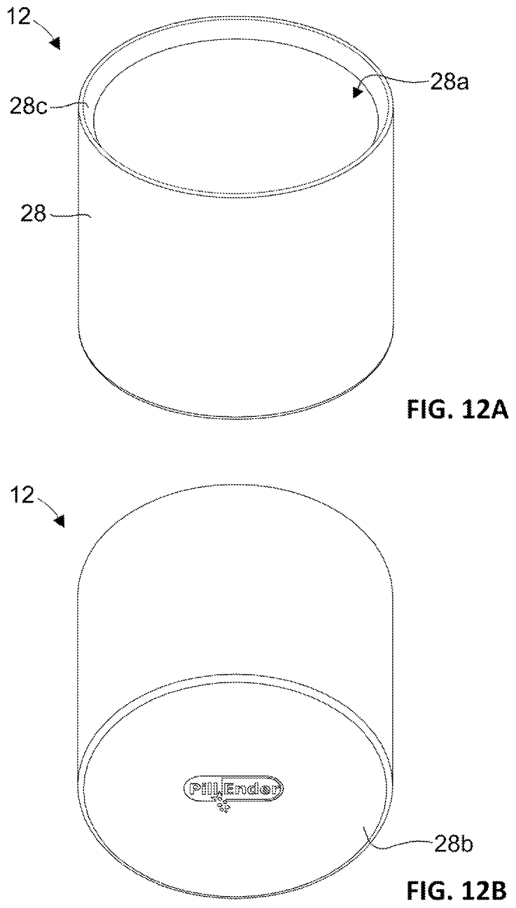

Referring to FIG. 1, the container 12 may comprise one or more of the container body 28, open end 28a, based end 28b, chamfer edge 28c, container inner wall 28e, and/or other components. The container body 28 may form a vessel to hold and/or contain ingredients within the container 12. In some implementations, the dimensions of the container 12 may be such that the internal volume of the container 12 can hold 1, 2, 3, 4, 5, 6, 7, 8, or more ounces. In certain embodiments, the internal volume of the container 12 may hold 3 fluid ounces, approximately. In some implementations, container 11 and/or container body 28 may have a cylindrical shape, as depicted in different views in FIG. 12A and FIG. 12B. In some implementations, the cylindrical shape of the container 11 and/or container body 28 may have a container diameter 28d (as shown in FIG. 10) in between 1.5 and 3 inches. In some implementations, the container diameter 28d may be 2 inches, approximately. Such a container diameter 28d may enhance portability, and may allow for more comfortable handheld operation of Blender 100.

Referring to FIG. 12A, in some implementations, the container inner wall 28e may have a chamfered edge 28c near the open end 28a of the container 12. In some implementations, chamfered edge 28c is designed to facilitate a smooth and easy insertion of the main body neck 18a, along with outer seal 26, into the container body 28 through open end 28a, ensuring a secure and leak-free mechanical coupling 25 between the main assembly 11 and the container 12. The mechanical coupling 25 between the main assembly 11 and the container 12 may allow for easy coupling and decoupling while also ensuring a leak-free connection during blending operations. In some implementations, mechanical coupling 25 may comprise a slip fit joint. For example, a proper mechanical coupling 25 between the main assembly 11 and container 12 of the Blender 100 can be achieved by aligning the main body neck 18a and outer seal 26 with the container open end 28a, and applying slight rotational force to the main assembly 11 while pushing it into the container 12. Similarly, to safely decouple Blender 100, hold the main assembly 11 and container 12 with separate hands and gently twist and pull them apart to avoid spills.

In some implementations, the outer seal 26 may be seated at or near the main body neck 18a. In some implementations, the outer seal 26 may be comprised of an O-ring or any other suitable sealing mechanism, to provide a secure and leak-proof connection between the main assembly 11 and the container 12.

In some implementations, the container body 28 may be transparent. In some implementations, the container body 28 may be made of a food-grade and/or durable material, e.g., polycarbonate, polypropylene, tritan, glass, stainless steel, nylon, or any other material. In some implementations, the container 12 may include measurement markings to help in the proper measurement of ingredients. Although the measurement markings are not shown in the figures, they may be included on the container body in any suitable configuration or unit of measure. In some implementations, the blended mixture or powder resulting from the use of the Blender 100 may be consumed either directly from the container 11 or by dispensing it into another container and/or carrier. This allows for flexibility in the consumption method and can accommodate personal preferences.

The Shaft housing 27 in conjunction with inner seal 27a may provide stability for the rotating shaft 29a, and prevents ingredients from entering into the main assembly 11. In some implementations, the shaft housing may have a tubular and/or conical shape with the tip point downward. In some implementations, the inner seal 27a may be an O-ring, may be disposed near or within shaft housing 27 to provide a tight seal around the rotating shaft 29a, preventing any leakage of ingredients into the main assembly 11. In some implementations, a stop washer 27b may be included in shaft housing 27 to serve as backup to keep the inner seal 27a securely in place within its intended sealing groove. In certain embodiments, the shaft housing may not include, but instead, the main body base 18b may be designed or configured to provide support for the rotating shaft 29a and prevent leakage into the main assembly 11.

In some implementations, the main assembly 11 may include a lanyard (not shown) or other carrying strap at or near the proximal end 17 to facilitate portability and handling of the Blender 100.

The disclosed implementations of the invention are provided as examples for the purpose of illustration, and should not be construed as limiting the scope of the invention. It will be appreciated that various modifications, alterations, and substitutions can be made to the implementations without departing from the spirit and scope of the invention as defined by the appended claims. For example, different materials, dimensions, and configurations can be used to implement the invention, and various combinations of features and components can be employed to achieve the intended function of the invention. Therefore, the invention is not limited to the disclosed implementations, and should be understood as encompassing all such modifications and variations that fall within the scope of the appended claims.

What is claimed is:

1. A Pill Blender configured to pulverize, mix, and blend ingredients, the Pill Blender comprising:
a main assembly, and a container, wherein the container includes:
an open end, a base end, a container inner wall, a container diameter, and a container body, wherein the container body is configured to contain ingredients;
wherein the main assembly includes:
a set of blades permanently supported by a vertical shaft that is rotationally connected to an electrical motor, wherein the set of blades is configured to rotate around a rotational axis to pulverize and blend ingredients, wherein the set of blades has a blade diameter during rotation, wherein the blade diameter is at least 32% of the container diameter;
an electrical motor integrated into the main assembly above the set of blades and in line with the rotational axis, configured to drive the rotation of the set of blades;
a power interface configured to conduct electrical power to the electrical motor, wherein the power interface is a standardized universal serial bus (USB) port configured to receive an electrical connector from an external power source;
a power button configured to be engaged manually by user to turn the electrical motor on and off;
a distal end that is disposed, subsequent to the container being mechanically coupled to the main assembly;
a proximal end disposed opposite to the distal end;
a longitudinal axis extending through the proximal end of the main assembly to the base end of the container;
a mechanical coupling configured to couple the main assembly to the container;
wherein the entire height of the Pill Blender is between 2.5 and 6 inches, when the main assembly is properly coupled to the container; and
wherein the Pill Blender has a cylindrical shape of diameter between 1.5 and 3 inches, wherein both the container and main assembly having diameters in the same range of 1.5 and 3 inches.

2. The Pill Blender of claim 1, wherein the rotational axis is parallel to the longitudinal axis of the container by an offset distance from the longitudinal axis, such that during rotation at least one distal end of the set of blades is in close proximity of the container inner wall, wherein the offset distance is between 5% and 34% of the container diameter.

3. The Pill Blender of claim 1, further comprising a safety switch is configured to enables or disables the rotation of the electric motor by detecting if the main assembly is properly attached to the container, where in the detection mechanism is based on the compression excreted by the container body onto the safety switch.

4. The Pill Blender of claim 1, wherein the power interface is further configured for charging the rechargeable battery.

5. The Pill Blender of claim 1, wherein the mechanical coupling is a slip fit connection.

6. The Pill Blender of claim 1, further includes an outer seal disposed near the distal end of the main assembly, wherein the outer seal is configured to form a leak-free slip fit connection in between the main assembly and the container.

7. The Pill Blender of claim 1, wherein the open end of the container has a chamfered edge on the container inner wall that is proportioned and dimensioned to allow the container to be easily coupled to the main assembly.

8. The Pill Blender of claim 1, wherein the container has a volume between 2 and 8 ounces.

9. The Pill Blender of claim 1, further comprising a lid disposed on top of the main body near the proximal end.

10. The Pill Blender of claim 1, wherein the shaft housing is configured to prevent leakage into the main body.

11. The Pill Blender of claim 1, further comprising a rechargeable battery configured to power the electrical motor, wherein the rechargeable battery has a capacity between 500 mAh and 5000 mAh.

12. The Pill Blender of claim 1, further comprising a control circuitry configured to control at least one function or operation of the blender selected from the group consisting of turning the blender on and off, controlling the electrical motor regarding and/or during rotation of the set of blades, determining whether mechanical couplings are engaged properly for blending, preventing rotation of the set of blades responsive to a determination that the mechanical couplings are not engaged properly, charging a rechargeable battery, and controlling an indicator light to convey information regarding the operational status of the blender to a user, wherein the control circuitry is included in the main assembly.

13. The Pill Blender of claim 1, wherein the electrical motor is configured to operate within a voltage range of 3 v to 9 v, and wherein the electrical motor is configured to spin the set of blades at a speed between 6,000 and 20,000 rotations per minute.

14. The Pill Blender of claim 1, wherein the set of blades is connected permanently to the main assembly.

15. The Pill Blender of claim 1, wherein the set of blades include 2, 3, 4, 5, or 6 blades, and wherein the set of blades include at least one blade that is pointed downward.

16. The Pill Blender of claim 9, wherein the lid further includes an indicator light, wherein the indicator light is configured to indicate the status of the blender or the blending process.

17. The Pill Blender of claim 1, wherein the main body comprises a shoulder and mortise slot that are configured to facilitate the correct mounting and alignment of the lid onto the main body.

18. The Pill Blender of claim 1, wherein the power button is further comprised of a compliant mechanism.

19. The Pill Blender of claim 1, wherein the power button is configured to switch the electrical motor between being powered by the direct power supply or the rechargeable battery.

20. The Pill Blender of claim 1, wherein the main assembly further includes a built-in compartment for convenient storage of ingredients, wherein the compartment exposed by removing the lid.
